(19) United States
(12) Patent Application Publication
(10) Pub. No.: US 2012/0193903 A1
(43) Pub. Date: Aug. 2, 2012

(54) Graphic Systems and Packages and Methods Of Using Graphic Systems

(75) Inventor: Clancy Gerald Boyer, Clarksville, OH (US)

(73) Assignee: PUR WATER PURIFICATION PRODUCTS, INC., Cincinnati, OH (US)

(21) Appl. No.: 13/192,843

(22) Filed: Jul. 28, 2011

Related U.S. Application Data
(60) Provisional application No. 61/369,888, filed on Aug. 2, 2010.
(60) Provisional application No. 61/370,907, filed on Aug. 5, 2010.

(51) Int. Cl. B42D 15/00; B65D 5/00; B65D 85/00

(52) U.S. Cl. 283/67; 206/459.5; 283/81

(57) ABSTRACT

A graphic system for a replacement cartridge for a consumer products device including a silhouette of the consumer products device, and a visual depiction of the replacement cartridge superimposed on the silhouette, wherein the visual depiction superimposed on the silhouette associates the correct replacement cartridge with the correct consumer product device.

### CROSS-REFERENCE TO RELATED APPLICATIONS

This application claims priority to U.S. Provisional Patent Application No. 61/369,888, filed Aug. 2, 2010 and U.S. Provisional Patent Application No. 61/370,907, filed Aug. 5, 2010, the details of which are incorporated herein by reference.

### TECHNICAL FIELD

The present specification generally relates to graphic systems and, more particularly, to graphic systems for packages.

### BACKGROUND

In consumer products devices that use replaceable cartridges, there is a need to accurately and quickly communicate to consumer the correct replacement cartridge for use in the consumer products device that the consumer already owns. This may be important for consumer products devices that belong to a family of devices, where all replacement cartridges are not interchangeable.

Previous attempts to communicate this information to the consumer were done with text printed on the box of the replaceable cartridges. This text, however, was seen as confusing by many consumers, and did not provide adequate assurance to these consumers that the replacement cartridge would fit their consumer products device. These consumers often would not purchase a replacement cartridge.

Accordingly, a need exists for alternative methods, systems and packages.

### SUMMARY

In one embodiment, a graphic system for a replacement cartridge for a consumer products device may include a silhouette of the consumer products device and a visual depiction of the replacement cartridge superimposed on the silhouette. The visual depiction superimposed on the silhouette may associate the correct replacement cartridge with the correct consumer product device.

In another embodiment, a replacement cartridge package may include a package wall and a graphical system disposed on the package wall. The graphical system may include a silhouette of a consumer products device and a visual depiction of a replacement cartridge for the consumer products device superimposed on the silhouette. The silhouette and the visual depiction may direct a consumer to select the replacement cartridge associated with the consumer products device.

In another embodiment, a product delivery system may include a package including an internal volume, a wall forming at least one side of the internal volume, and an opening in the wall. The product delivery system may also include a silhouette of a consumer products device and a replacement cartridge held inside the internal volume. The replacement cartridge may be visible through the opening, and the silhouette may direct a consumer to select the replacement cartridge associated with the consumer products device.

In yet another embodiment, a method of directing a consumer to select a replacement cartridge associated with a consumer products device may include providing a package holding the replacement cartridge, indicating to the consumer a contents of the package through the use of a visual depiction of the replacement cartridge, and indicating to the consumer which consumer product device the replacement cartridge is associated with through the use of a silhouette of the consumer product device. The visual depiction and the silhouette may be displayed on an exterior surface of the package.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a graphic system according to one or more embodiments shown and described herein;

FIG. 2 schematically depicts a graphic system on a package blank according to one or more embodiments shown and described herein;

FIG. 3 schematically depicts a graphic system according to one or more embodiments shown and described herein;

FIG. 4 schematically depicts a graphic system on a package blank according to one or more embodiments shown and described herein;

FIG. 5 schematically depicts a graphic system according to one or more embodiments shown and described herein;

FIG. 6 schematically depicts a graphic system according to one or more embodiments shown and described herein;

FIG. 7 schematically depicts a graphic system according to one or more embodiments shown and described herein;

FIG. 8 schematically depicts a graphic system according to one or more embodiments shown and described herein;

FIG. 9 schematically depicts a graphic system according to one or more embodiments shown and described herein;

FIG. 10 schematically depicts a graphic system according to one or more embodiments shown and described herein; and

FIG. 11 schematically depicts a graphic system according to one or more embodiments shown and described herein.

### DETAILED DESCRIPTION

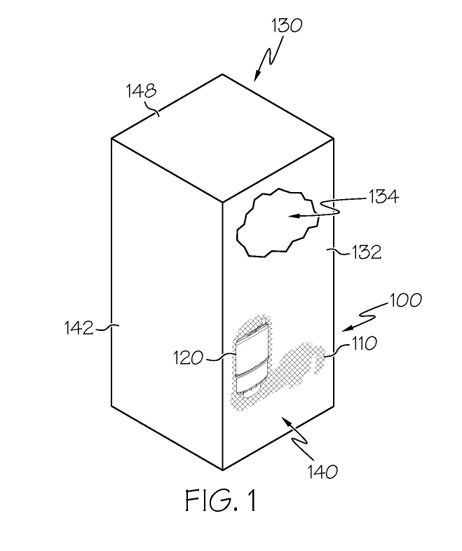

FIG. 1 generally depicts one embodiment of a graphic system for accurately communicating with a consumer. The graphic system may include a visual depiction of a replacement cartridge for a consumer products device and a silhouette of the consumer products device that that replacement cartridge is associated with. Consumers may be able to purchase a replacement cartridge for a consumer product device that the consumer already owns. By superimposing the visual depiction on the silhouette, consumers are able to quickly and/or accurately identify the replacement cartridge that is associated with their consumer products device.

Referring now to FIG. 1 in detail, a graphic system 100 for a replacement cartridge for a consumer device may include a silhouette 110 of the consumer products device and a visual depiction 120 of the replacement cartridge. As used herein, silhouette means an image of an object with a featureless interior. A silhouette may be filled with any color that contrasts with the background on which is appears. A silhouette does not include a photographic image.

Visual depiction, as used herein, means a printed image of an object (e.g., a replacement cartridge). Examples of visual depictions include, but are not limited to, an illustration (e.g., realistic illustration), rendering (e.g., product rendering, photo rendering), photographic image (e.g., printed photographic image), visual indicia, and visual indicia representation. The visual depiction may be an analog or digital image of an object and may be printed on any medium as conventionally known. The visual depiction 120 may associate the correct replacement cartridge with the correct consumer products device. As used herein, associate means demonstrating graphically to the consumer that the replacement cartridge is meant to be used with the consumer products device. For example, in the embodiment depicted in FIG. 1, the graphic system 100 is directed towards a water filter cartridge (i.e., replacement cartridge) that is used in a faucet-mounted water filter (i.e., consumer products device).

In one embodiment, the silhouette 110 may be superimposed on a field 132. The silhouette 110 and the field 132 may each have a color. The color of the silhouette 110 and the background color of the field 132 may contrast, i.e., so that the silhouette 110 is distinguishable from the background color of the field 132. In one embodiment, the silhouette 110 may be superimposed on the field 132 without a border around the silhouette 110. In another embodiment, the silhouette 110 may be superimposed on a field 132 with a border outlining the shape of the silhouette 110. In another embodiment, the silhouette 110 and the field 132 may have a plurality of colors, where the colors of the silhouette 110 contrast with the colors of the field 132. Examples of contrasting colors may include, but are not limited to: a light blue silhouette 110 on a dark blue field 132; a green silhouette 110 on a dark blue field 132; a magenta silhouette 110 on a dark blue field 132; and an orange silhouette 110 on a dark blue field 132.

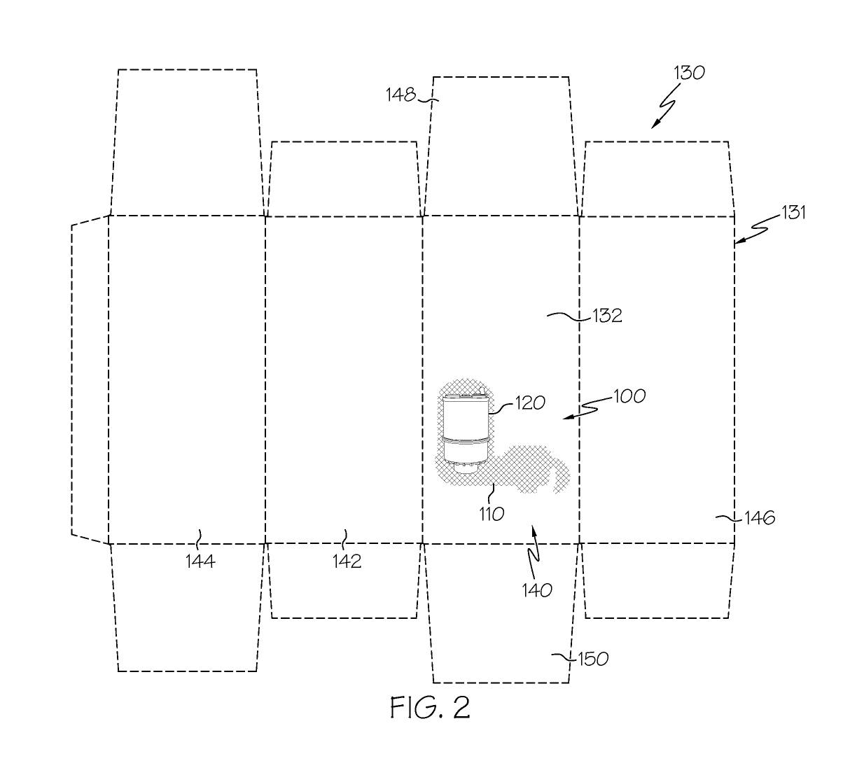

The graphic system 100 may be used with a variety of consumer products devices that use replacement cartridges. FIGS. 1 and 2 are directed towards packages for a water filter cartridge used with a faucet-mounted water filter. The package 130 may a graphic system 100 including a silhouette 110 of a faucet-mounted water filter and a visual depiction 120 of a water filter cartridge that is used in a faucet-mounted water filter superimposed on the silhouette 110. The package 130 may be printed as a blank 131, as depicted in FIG. 2, which is then trimmed, folded, and secured to form a three-dimensional package 130, as depicted in FIG. 1.

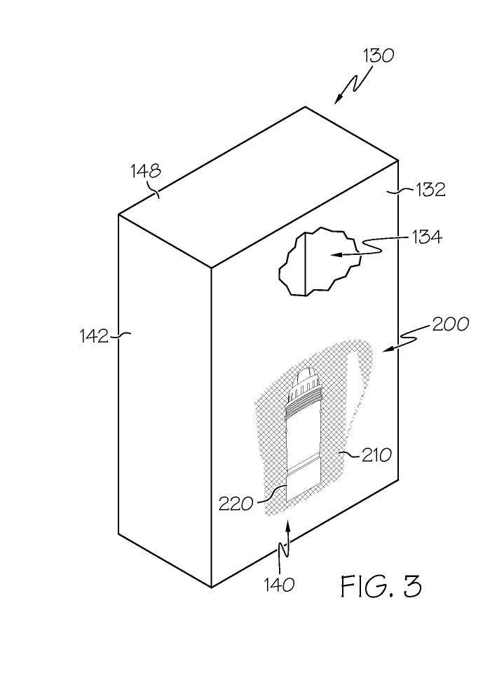

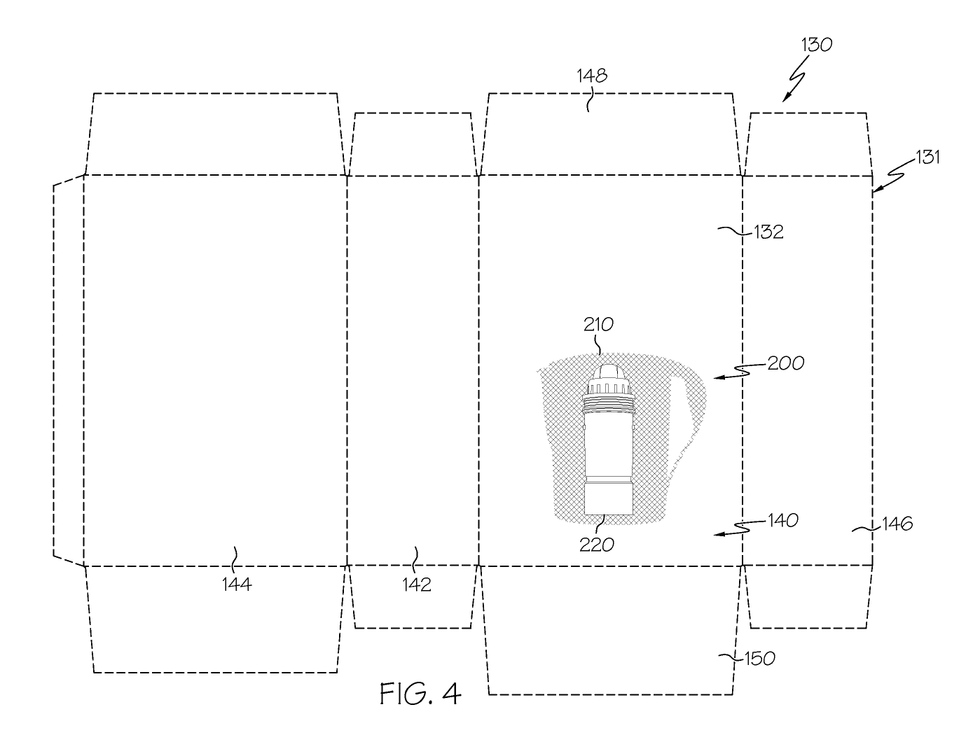

FIGS. 3 and 4 are directed towards packages for a water filter cartridge used with a pitcher-based water filter. The package 130 may include a graphic system 200 that includes a silhouette 210 of a pitcher-based water filter and a visual depiction 220 of a water filter cartridge that is used in a pitcher-based water filter superimposed on the silhouette 210. The package 130 may be printed as a blank 131, as depicted in FIG. 4, which is then trimmed, folded, and secured to form a three-dimensional package 130, as depicted in FIG. 3.

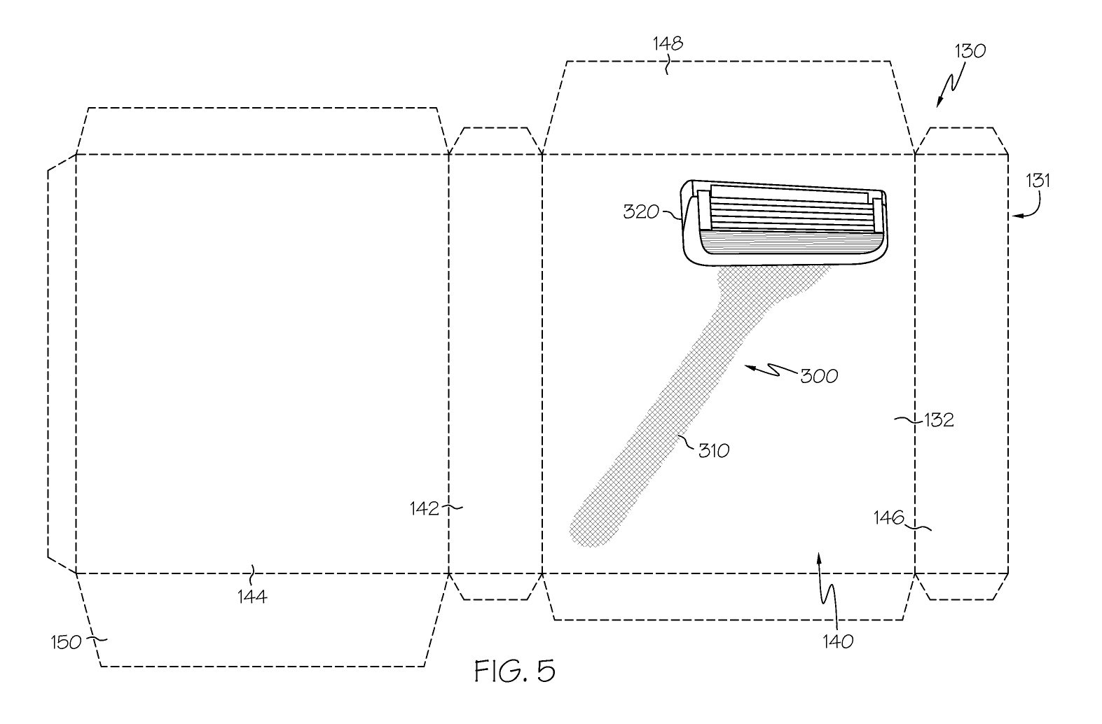

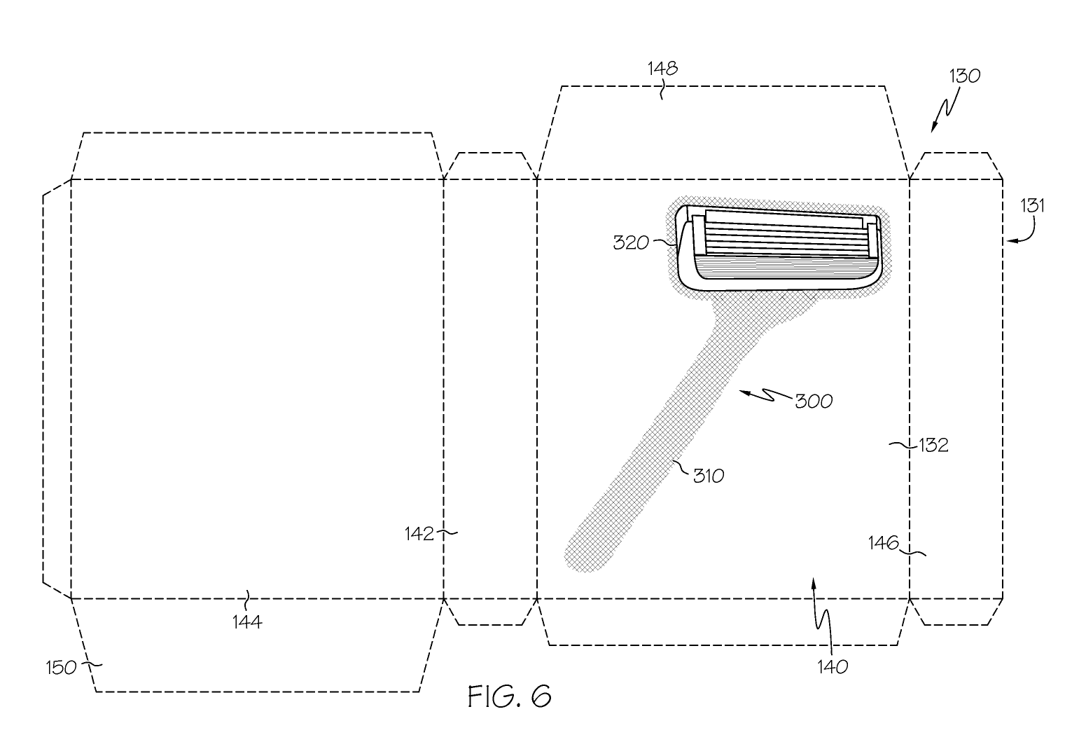

FIGS. 5 and 6 are directed towards packages for a razor cartridge used with a razor handle. As depicted in FIG. 5, the package 130 may be formed from a blank 131 including a graphic system 300 which may include a silhouette 310 of a razor handle and a visual depiction 320 of a razor cartridge superimposed on the silhouette 310. In another embodiment, depicted in FIG. 6, the package 130 may be formed from a blank 131 including a graphic system 300 which may include a silhouette 310 of an assembly of a razor handle and a razor cartridge with a visual depiction 320 of a razor cartridge superimposed on the silhouette 310.

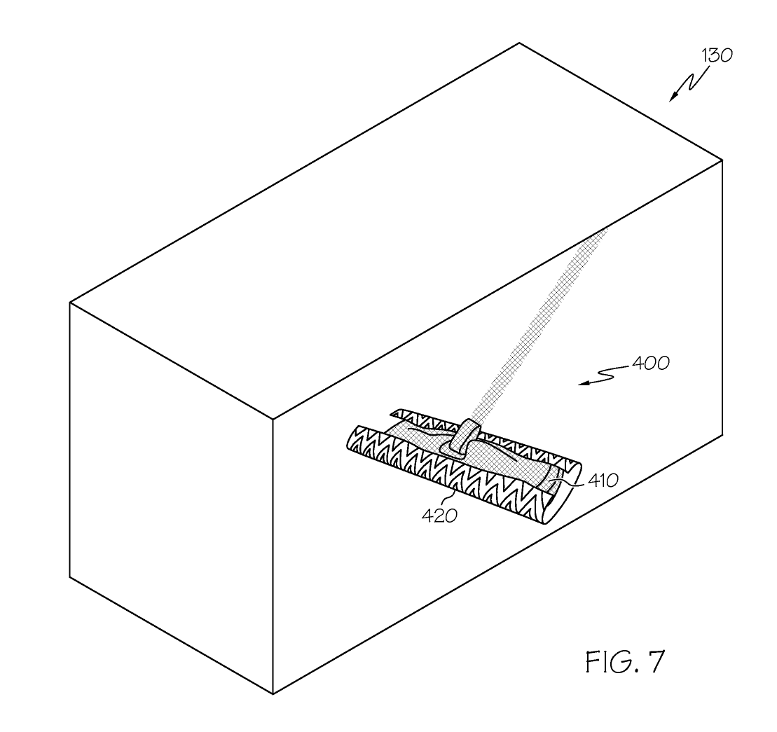

FIG. 7 is directed towards a package 130 for a cleaning cloth used with a mop for receiving said cleaning cloth. The package 130 may include a graphic system 400 that includes silhouette 410 of a mop and a visual depiction 420 of a cleaning cloth superimposed on the silhouette 410.

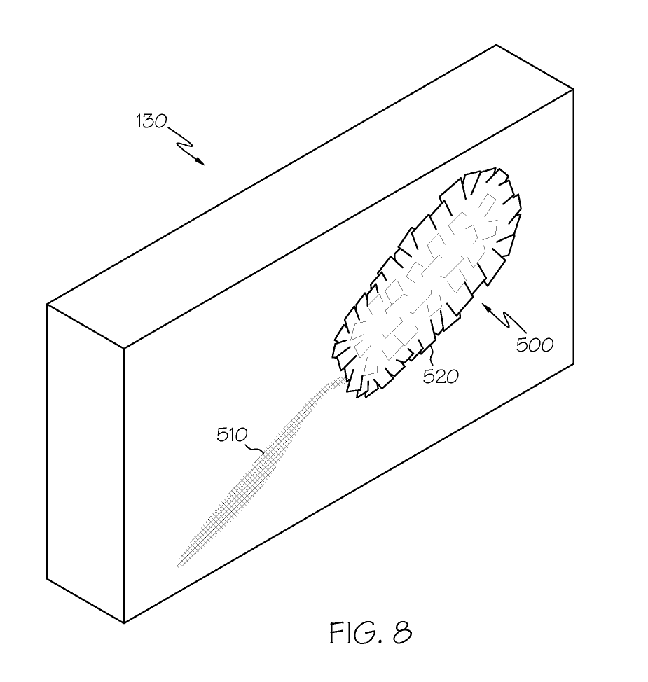

FIG. 8 is directed towards a package 130 for a dusting head used with a handle for receiving said dusting head. The package 130 may include a graphic system 500 that includes a silhouette 510 of a handle and a visual depiction 520 of a dusting head superimposed on the silhouette 510.

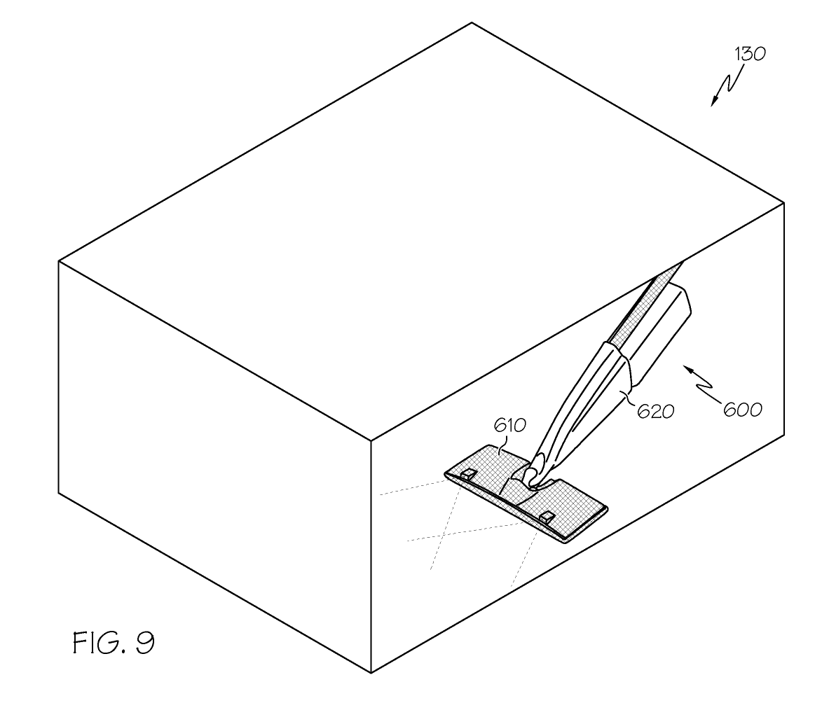

FIG. 9 is directed towards a package 130 for a surface treating solution used with a mop device for applying said solution to a target surface. The package 130 may include a graphic system 600 that includes a silhouette 610 of a mop device and a visual depiction 620 of a container of surface treating solution superimposed on the silhouette 610.

Based on product testing, the use of the graphic system 100 has been found to be beneficial for communicating to consumers what replacement cartridge should be used for a certain consumer products device, particularly when there are a series of replacement cartridges available for a class of products. Using water filter cartridges as an example, water filter cartridges (i.e., replacement cartridges) are available for a class of products: FIG. 1 is directed towards a water filter cartridge for a faucet-mounted water filter; FIG. 3 is directed towards a water filter cartridge for a pitcher-based water filter. In one embodiment of the products, replacement cartridges are not interchangeable between faucet-mounted water filter and pitcher-based water filters. Consumers have typically had some difficulty in determining which replacement water filter cartridge was appropriate for their water filter device (e.g., faucet-mounted or pitcher-based application). Product testing showed that providing consumers with a package 130 that included the graphic system 100 having a silhouette 110 and a visual depiction 120 of a water filter cartridge helped the consumers distinguish between water filter cartridges that were used in faucet-mounted water filters and pitch-based water filters, as compared to a package that did not include a graphic system 100. The graphic system 100 was able to quickly communicate to the consumers which water filter the water filter cartridge was associated with. The package 130 with the graphic system 100 including a silhouette 110 and visual depiction 120 may have demonstrated an ability to create a greater connection in the mind of consumers than a package without the graphic system. Similarly, for razor cartridges, the color of the silhouette 310 may correspond with the number of blades in a replacement cartridge.

In one embodiment, the color of the silhouette 110 may correspond with a feature and/or characteristic of the replacement cartridge. For example, as depicted in FIG. 1 for a water filter cartridge, the color of the silhouette 110 may correspond with a filtering level of the water filter cartridge. For example, a water filter cartridge that uses a two-stage filtering technology may have a blue silhouette 110, a water filter cartridge that uses a three-stage filtering technology may have a green silhouette 110, and a water filter cartridge that uses a four-stage filtering technology may have an orange silhouette 110. Using mops receiving cleaning cloths, as depicted in FIG. 7, as an example, a cleaning cloth that is dry may have a green silhouette 410 while a cleaning cloth that is wet may have a blue silhouette 410. Similarly, using razor cartridges, as depicted in FIGS. 5 and 6, as examples, the color of the silhouette 310 may correspond with the number of blades in a replacement cartridge.

The use of color of the silhouette 110 may be beneficial for use with class of products with non-interchangeable cartridges. For example, a consumer may wish to have different functionality across the product class. Using the water filter cartridge example described previously, a consumer who owns both a faucet-mounted water filter and a pitcher-based water filter may prefer to have different levels of filtering for the different products. The consumer may prefer to use a two-stage filter with the faucet-mounted water filter and a three-stage filter with a pitcher-based water filter. The use of color in the silhouette 110 helps to inform the consumer which level of filtering is provided by the replacement water filter. In this example, the consumer would choose a water filter cartridge having a blue silhouette 110 of a shape of a faucet-mounted water filter and a water filter cartridge having a green silhouette 210 in a shape of a pitcher-based water filter.

Conversely, if a consumer uses multiple products in the class and wishes to select replacement cartridges with the same level of functionality, the use of color in the silhouette 110 assists as well. For example, if a consumer uses a faucet-mounted water filter at home and a pitcher-based water filter at the office, and the consumer is satisfied with the performance of a particular filtering level of the faucet-mounted water filter, the colors of the silhouettes 110, 210 assist the consumer in selecting a replacement filter for the pitcher-based water filter that has an equivalent filtering level. Although certain colors were described in the embodiments above, it is understood that any color or other symbols may be used with the embodiments shown and described herein.

The graphic system 100 may be included on a package 130 for a replacement cartridge for a consumer products device. As depicted in FIG. 2, the graphic system 100 may be printed on a blank 131, which is subsequently trimmed and formed into a package 130. The graphic system 100 may be printed on a package wall 140 of the blank 131. When the blank 131 is trimmed and folded into shape, as depicted by the package 130 in FIG. 1, the package 130 may have an internal volume 134 where the package wall 140 forms at least one side of the internal volume 134. A replacement cartridge (not shown) may be placed within the internal volume 134 of the package 130, where the replacement cartridge matches the visual depiction 120 shown on the package 130.

The visual depiction 120 may be positioned relative to the silhouette 110 such that the positioning of these two elements represents how the replacement cartridge is positioned within the consumer products device. Using FIGS. 1 and 3 as examples, the visual depictions 120, 220 are superimposed on the silhouettes 110, 210 in the same location that the water filter cartridges would be placed within the water filtering devices.

In one embodiment, the visual depiction 120 may be shown at the same scale as the silhouette 110. A ratio of the size of the visual depiction 120 to the size of the silhouette 110 may be equivalent to a ratio of the size of the replacement cartridge to the size of the consumer products device. In another embodiment, the visual depiction 120 may be shown at a scale larger than the silhouette 110. A ratio of the size of the visual depiction 120 to the size of the silhouette 110 may be greater than a ratio of the size of the replacement cartridge to the size of the consumer products device. In another embodiment, the visual depiction 120 may be shown at a scale smaller than the silhouette 110. A ratio of the size of the visual depiction 120 to the size of the silhouette 110 may be less than a ratio of the size of the replacement cartridge to the size of the consumer product device.

As depicted in FIGS. 1 and 2, the package 130 may further include a second package wall 142 connected to the package wall 140, a third package wall 144 connected to the second package wall 142 and opposite to the package wall 140, and a fourth package wall 146 connected to the third package 144 wall and opposite to the second package wall 142. The package 130 may further include a first end 148 connected to at least one of the package wall 140, the second package wall 142, the third package wall 144, or the fourth package wall 146. The package 130 may further include a second end 150 opposite to the first end 148 and connected to at least one of the package wall 140, the second package wall 142, the third package wall 144, or the fourth package wall 146. The package 130 is depicted in FIG. 2 as a blank 131, or in an “unwrapped” state to assist with visualization.

The package 130 and the graphic system 100 may be constructed from a variety of materials and produced by a variety of methods. In one embodiment, the package 130 may be constructed from paperboard. In another embodiment, the package 130 may be constructed from a polymer. In one embodiment, the package 130 may be fabricated from a polymer, plastics, and/or composite materials using any conventional methods, including but not limited to injection molding, blow molding, thermoforming, casting, or combinations thereof. In one embodiment, the graphic system 100 may be printed directly onto a surface of the package 130. In another embodiment, the graphic system may be applied to a surface of the package 130 as a decal and/or label. In another embodiment, the graphic system may be applied to a surface of the package 130 as a sticker. In yet another embodiment, package 130 may be formed of a clear polymer and the graphic system 100 placed inside the package 130 so that the silhouette 110 and the visual depiction 120 are visible through a wall of the package 130.

In one embodiment, some or all of the graphic system 100 may be shown in relief on a package wall 140 of the package 130. In one embodiment, the visual depiction 120 may have its shape embedded in the package wall 140 so that the visual depiction 120 either stands out or is set back from the rest of package wall 140. In another embodiment, the silhouette 110 may have its shape embedded in the package wall 140 so that the silhouette 110 and the superimposed visual depiction 120 either stands out or is set back from the rest of the package wall 140. As an example, the silhouette 110 may be molded within the package wall 140.

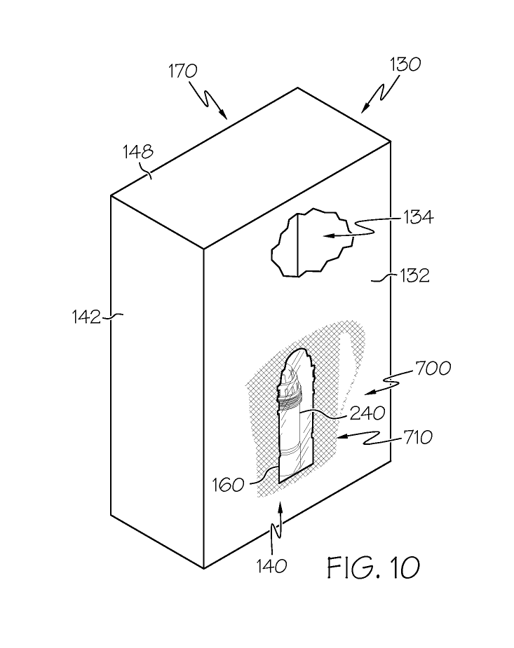

As depicted in FIG. 10, a product delivery system 170 may include a package 130 that includes an internal volume 134, a package wall 140 forming at least one side of the internal volume 134, and graphic system 700. The graphic system 700 may include an opening 160 in the package wall 140. The opening 160 may be positioned and shaped so that a replacement cartridge 240 held inside the internal volume 134 is visible through the opening 160. In one embodiment, a silhouette 710 of the consumer products device may be included on the package wall 140. The silhouette 710 may have a color that corresponds to a feature of the replacement cartridge, as discussed above.

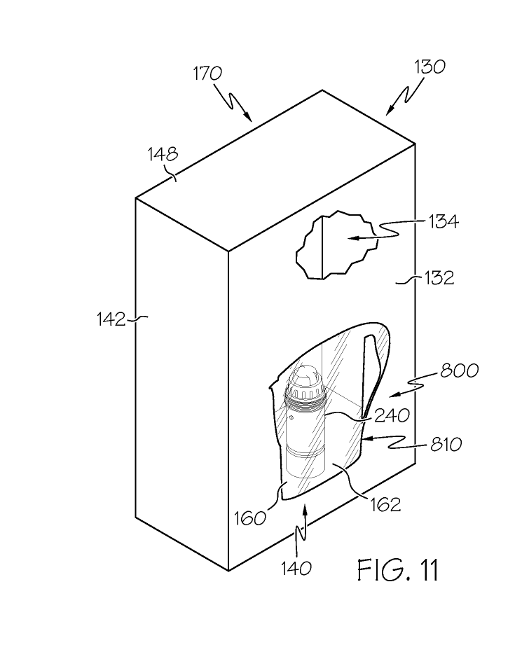

In another embodiment, as depicted in FIG. 11, a product delivery system 170 may include a package 130 that includes an internal volume 134, a package wall 140 forming at least one side of the internal volume 134, and a graphic system 800. The graphic system 800 may include an opening 160 in the package wall 140 and may take the form of the consumer products device, thus creating a silhouette 810 in the package wall 140 itself. In yet another embodiment, the opening 160 may take the form of the consumer products device and the replacement cartridge 240 may be held by an internal support 162. The portion of the internal support 162 viewable through the opening 160 of the package wall 140 may create a silhouette 810. Further, the internal support 162 may have a color that corresponds with a feature of the replacement cartridge, as discussed above.

It should now be understood that graphics systems for packages include a visual depiction of a replacement cartridge for a consumer products device superimposed over a silhouette of the consumer products device. This graphic system may associate the correct replacement cartridge with the correct consumer products device. The graphic system may be incorporated into packages for a variety of replacement cartridges in a variety of manners.

It should now be apparent that the various embodiments of the graphic systems may be suitable to a variety of products. While particular reference has been made herein to products for containing replacement cartridges for consumer products devices, it should be apparent that the graphic systems discussed herein may be suitable for use in conjunction with products for use in the consumer goods industry, the food service industry, the transportation industry, the medical industry, the toy industry, and the like.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A graphic system for a replacement cartridge for a consumer products device comprising:
a silhouette of the consumer products device; and
a visual depiction of the replacement cartridge superimposed on the silhouette;
wherein the visual depiction superimposed on the silhouette associates the correct replacement cartridge with the correct consumer product device.

2. The graphic system of claim 1, wherein the visual depiction is positioned relative to the silhouette in a location corresponding with a position of the replacement cartridge relative to the consumer products device.

3. The graphic system of claim 1, further comprising a field, the silhouette being superimposed on the field.

4. The graphic system of claim 3, wherein the silhouette comprises a color, the color contrasting with a background color of the field.

5. The graphic system of claim 4, wherein the color of the silhouette corresponds with a feature of the replacement cartridge.

6. The graphic system of claim 3, wherein the silhouette comprises a plurality of colors, the colors contrasting with a background color of the field.

7. The graphic system of claim 1, wherein a ratio of a size of the visual depiction relative to a size of the silhouette is greater than a ratio of a size of the replacement cartridge relative to a size of the consumer products device.

8. The graphic system of claim 1, wherein the replacement cartridge comprises a water filter cartridge and the consumer products device comprises a water filtering device.

9. The graphic system of claim 1, wherein the replacement cartridge comprises a razor cartridge and the consumer products device comprises a razor handle.

10. The graphic system of claim 1, wherein the replacement cartridge comprises a cleaning cloth and the consumer products device comprises a mop for receiving said cleaning cloth.

11. The graphic system of claim 1, wherein the replacement cartridge comprises a dusting head and the consumer products device comprises a handle for receiving said dusting head.

12. The graphic system of claim 1, wherein the replacement cartridge comprises a surface treating solution and the consumer products device comprises a mop device for applying said solution to a target surface.

13. A replacement cartridge package comprising:
a package wall; and
a graphical system disposed on the package wall, the graphical system comprising:
a silhouette of a consumer products device, and
a visual depiction of a replacement cartridge for the consumer products device superimposed on the silhouette,
wherein the silhouette and the visual depiction direct a consumer to select the replacement cartridge associated with the consumer products device.

14. The package of claim 13, further comprising:
an internal volume, the package wall forming at least one side of the internal volume;
a replacement cartridge contained within the internal volume that matches the replacement cartridge shown in the visual depiction.

15. The package of claim 13, wherein the silhouette and the visual depiction are disposed on an exterior surface of the package wall.

16. The package of claim 13, wherein the package wall comprises paperboard.

17. The package of claim 13, further comprising:
a second package wall connected to the package wall;
a third package wall connected to the second package wall opposite the package wall;
a fourth package wall connected to the third package wall opposite the second package wall;
a first end connected to at least one of the package wall, second package wall, third package wall, or fourth package wall; and
a second end opposite the first end and connected to at least one of the package wall, second package wall, third package wall, or fourth package wall.

18. The package of claim 13, wherein the package wall comprises a polymer.

19. The package of claim 13, wherein the silhouette is in relief from an exterior surface of the package wall.

20. The package of claim 13, wherein the package wall comprises a clear polymer, the silhouette and the visual depiction being visible through the package wall.

21. A product delivery system comprising:
a package comprising:
an internal volume,
a wall forming at least one side of the internal volume, and
an opening in the wall;
a silhouette of a consumer products device; and
a replacement cartridge held inside the internal volume;
wherein the replacement cartridge is visible through the opening, and the silhouette directs a consumer to select the replacement cartridge associated with the consumer products device.

22. The product delivery system of claim 21, wherein the silhouette is printed on the wall of the package and the opening takes a form of the replacement cartridge.

23. The product delivery system of claim 21, wherein the opening comprises a form of the consumer products device.

24. The product delivery system of claim 21, further comprising an internal support, the internal support holding the replacement cartridge inside the package, wherein the silhouette is formed by a color contrast of the internal support and exterior wall of the package.

25. A method of directing a consumer to select a replacement cartridge associated with a consumer products device comprising:
providing a package holding the replacement cartridge;
indicating to the consumer a contents of the package through the use of a visual depiction of the replacement cartridge; and
indicating to the consumer which consumer product device the replacement cartridge is associated with through the use of a silhouette of the consumer product device;
wherein the visual depiction and the silhouette are displayed on an exterior surface of the package.

26. The method of claim 25, further comprising superimposing the visual depiction onto the silhouette.

27. The method of claim 25, further comprising indicating to the consumer a feature of the replacement cartridge through the use of a color of the silhouette.
